(19) United States
(12) Patent Application Publication
(10) Pub. No.: US 2023/0153005 A1
(43) Pub. Date: May 18, 2023

(54) Block Storage Device and Method for Data Compression

(71) Applicant: Huawei Technologies Co., Ltd., Shenzhen (CN)

(72) Inventors: Zvi Schneider, Hod Hasharon (IL); Assaf Natanzon, Hod Hasharon (IL)

(21) Appl. No.: 18/156,824

(22) Filed: Jan. 19, 2023

Related U.S. Application Data
(63) Continuation of application No. PCT/EP2020/070795, filed on Jul. 23, 2020.

(51) Int. Cl. G06F 3/06

(52) U.S. Cl. CPC G06F 3/0641; G06F 3/0608; G06F 3/0659; G06F 3/0673

(57) ABSTRACT

A block storage device, for data compression is configured to, in a first operating phase, if it is determined, by the block storage device, that a data block is to be written to a large block storage area of the block storage device, determine if the data block can be de-duplicated. If the data block cannot be de-duplicated, the block storage device stores the data block using large block compression.

### CROSS-REFERENCE TO RELATED APPLICATIONS

This application is a continuation application of International Patent Application No. PCT/EP2020/070795 filed on Jul. 23, 2020. The disclosure of the aforementioned application is hereby incorporated by reference in its entirety.

### TECHNICAL FIELD

The present disclosure relates to the field of storage devices, in particular block storage devices. Furthermore, a device and a method are provided, which enable applying large block compression to a data block, if de-duplication is not possible.

### BACKGROUND

Conventional storage devices that implement two phase data reduction are designed to minimize central processing unit (CPU) usage during an initial inline phase and maximize data-reduction during later background processing.

During the inline phase, the conventional storage device generates a hash fingerprint of an input data block and compares it with existing fingerprints. If a match is found, the storage device performs de-duplication. That is, rather than storing the data block, it stores a pointer to an existing, identical data block. If de-duplication is not possible, the system compresses and stores the data. During the background process, the conventional storage device attempts to further improve size of the stored data block.

Conventional storage devices may use several data reduction methods in the inline phase. As already mentioned, a conventional approach is fixed size de-duplication. In this approach an input data block is divided into aligned blocks of a fixed size, for example, 4 kilobytes (kB), 8 kB, 16 kB, etc. For each block, a strong hash fingerprint is generated. If a block that is to be written has the same signature as an already-written block, it is considered identical. Therefore, instead of storing the data again, a pointer is kept to the identical block.

A further conventional approach is similarity compression. In this approach, a similarity hash function (for example, a min-hash function) is generated for each data block and stored in an opportunity table. The conventional storage device considers data blocks similar if they have the same similarity hash. This means that a part of data in a data block is identical to a part of data in another block. Thus, a part of one data block is identical to a part of another data block and overall, the data blocks are similar, but not identical. This allows storage of only the non-identical part of a data block and use of a pointer to that part of a similar data block which is identical to the part of a current data block, or perform a differential compression using the similar block as a reference.

However, drawbacks of the conventional storage devices are that they only support compression of data blocks up to a very small size, which results in low compression efficiency. Additionally, the conventional storage devices do not support multiple data reduction methods, in particular not in a granular configuration manner. Furthermore, the 2-phase approach is limited to a static configuration.

### SUMMARY

In view of the above-mentioned problem, an objective of embodiments of the present disclosure is to improve the conventional storage device.

This or other objectives may be achieved by embodiments of the present disclosure as described in the enclosed independent claims. Advantageous implementations of embodiments of the present disclosure are further defined in the dependent claims.

A first aspect of the present disclosure provides a block storage device for data compression, configured to, in a first operating phase, if it is determined, by the block storage device, that a data block is to be written to a large block storage area of the block storage device, determine if the data block can be de-duplicated, and if the data block cannot be de-duplicated, store the data block using large block compression.

This ensures that the block storage device can apply large block compression to a data block, if the area to which the data block should be written to is a large block storage area (that is, where typically large blocks are written to or read from). This improves effectivity of data reduction due to the increased effectivity of large block compression.

In particular, large block compression means that the whole data block is compressed at once. In particular, large block compression means that the whole data block is not divided into sub blocks, before compression is applied. In particular, large block compression means that compression is applied to a data block having a size larger than a predefined threshold. In particular, the predefined threshold can be one of the following file sizes: 128 kB, 256 kB, 512 kB, 1 megabyte (MB), 2 MB, 4 MB, 8 MB and so on.

In particular, determining that the data block is to be written to a large block storage area, the determining if the data block can be de-duplicated, and the large block compressing of the data block are performed during the first operating phase.

In particular, the large block storage area comprises at least a part of a virtual or physical disk, and/or at least a part of a virtual or physical partition.

In particular, de-duplication comprises, if the data block comprises at least two identical sub blocks, only store one of the identical sub blocks and for each remaining sub block, keep a pointer to the stored sub block. That is, instead of N identical sub blocks, only one sub blocks and (N−1) pointers to this sub block are required.

In an implementation form of the first aspect, the large block storage area is an area where data blocks having an average size larger than a predefined threshold are written to, and/or are read from.

This ensures that the block storage device can detect a storage area where large block compression can be effectively applied.

In particular, the predefined threshold can be one of the following file sizes: 128 kB, 256 kB, 512 kB, 1 MB, 2 MB, 4 MB, 8 MB and so on.

In a further implementation form of the first aspect, the block storage device is further configured to determine the average size based on a read statistic and/or a write statistic.

This provides a suitable measure for determining an average input/output (IO) size.

In a further implementation form of the first aspect, the first operating phase is an in-line phase.

This ensures that the block storage device can be used in an in-line phase.

In particular, the in-line phase is performed in association with a write operation of the data block.

In a further implementation form of the first aspect, the block storage device is further configured to, if the data block can be de-duplicated, de-duplicate and compress the data block and store the resulting data block.

This ensures that multiple data reduction techniques can be selected from, and/or applied to the data block simultaneously, to maximize the effect of data reduction. Moreover, an optimal reduction technique can be chosen.

In particular, in this case the data block is divided into small sub blocks (for example of 8 KB), de-duplicated at the small granularity of 8 KB and also compressed in the small granularity.

In particular, the compression applied in this step is different from large block compression.

In a further implementation form of the first aspect, the block storage device is further configured to, if the data block can be de-duplicated, compare a size resulting from de-duplication and compression of the data block with a size resulting from large block compression of the data block.

This ensures, that several data reduction techniques can be evaluated.

In a further implementation form of the first aspect, the block storage device is further configured to, if the size resulting from de-duplication and compression is larger than or equal to the size resulting from large block compression, store the data block using large block compression.

This ensures that a most effective data reduction technique is chosen.

In particular, the block storage device is further configured to, if the size resulting from de-duplication and compression is smaller than the size resulting from large block compression, store the data block using de-duplication and compression.

In a further implementation form of the first aspect, the block storage device is further configured to de-duplicate a first part of sub blocks of the data block and compress a second part of sub blocks of the data block and store the resulting data block, to de-duplicate and compress the data block.

This provides a detailed implementation of simultaneously applying de-duplication and compression, to maximize the effect of data reduction.

In particular, the first part of sub blocks and the second part of sub blocks together form all sub blocks of the data block. In particular, the first part and the second part do not overlap.

In particular, the compression applied in this step is different from large block compression, in that it is not applied to the overall data block, but instead is applied to at least one sub block of the data block.

In a further implementation form of the first aspect, the block storage device is further configured to, for each sub block of the data block, write a similarity hash to a similarity hash table.

This ensures that in the first operating stage, prerequisites of similarity de-duplication in the second operating phase can be completed, i.e. at a time when it is most efficient to obtain and write similarity hashes of the sub blocks.

In particular, one similarity hash corresponds to one sub block.

In a further implementation form of the first aspect, the block storage device is further configured to, in a second operating phase, determine, based on a similarity hash, if a data block stored in the first operating phase can be further reduced in size using similarity de-duplication.

This ensures that in the second operating phase, the data block can be further reduced in size, in particular be a size reduction technique which is most suitable for the second operating phase.

In particular, the similarity hash is the similarity hash stored in the similarity hash table.

In particular, similarity de-duplication includes that de-duplication is also applied to all sub blocks of a data block.

In a further implementation form of the first aspect, the block storage device is further configured to determine space required for storing the data block using similarity de-duplication and to determine space required for storing the data block in its present format.

This ensures that the effectivity of similarity de-duplication can be evaluated.

In particular, the present format either is large block compression, or a combination of de-duplication and compression.

In a further implementation form of the first aspect, the block storage device is further configured to only store the data block in the data storage using similarity de-duplication, if the space required for storing the data block using similarity de-duplication is less than the space required for storing the data block in its present format.

This ensures that in the second operating phase, the most effective way of data reduction is chosen. Similarity de-duplication in particular is only chosen, if it is more effective than a present format for storing the data block.

In a further implementation form of the first aspect, the second operating phase is an offline phase.

This ensures that the block storage device can be used in an offline phase.

In particular, the offline phase is performed periodically. In particular, periodically means according to a predefined time interval. In particular, periodically means that this operating phase is performed independent from write and/or read operations.

A second aspect of the present disclosure provides a method for data compression, the method comprising the steps of, in a first operating phase, if it is determined, by a block storage device, that a data block is to be written to a large block storage area of the block storage device, determining, by the block storage device, if the data block can be de-duplicated, and if the data block cannot be de-duplicated, storing, by the block storage device, the data block using large block compression.

In an implementation form of the second aspect, the large block storage area is an area where data blocks having an average size larger than a predefined threshold are written to, and/or are read from.

In a further implementation form of the second aspect, the method further includes determining, by the block storage device, the average size based on a read statistic and/or a write statistic.

In a further implementation form of the second aspect, the first operating phase is an in-line phase.

In a further implementation form of the second aspect, the method further includes, if the data block can be de-duplicated, de-duplicating and compressing, by the block storage device, the data block and storing, block storage device, the resulting data block.

In a further implementation form of the second aspect, the method further includes, if the data block can be de-duplicated, comparing, by the block storage device, a size resulting from de-duplication and compression of the data block with a size resulting from large block compression of the data block.

In a further implementation form of the second aspect, the method further includes, if the size resulting from de-duplication and compression is larger than or equal to the size resulting from large block compression, storing, by the block storage device, the data block using large block compression.

In a further implementation form of the second aspect, method further includes de-duplicating, by the block storage device, a first part of sub blocks of the data block and compressing, by the block storage device, a second part of sub blocks of the data block and storing, by the block storage device, the resulting data block, to de-duplicate and compress the data block.

In a further implementation form of the second aspect, the method further includes, for each sub block of the data block, writing, by the block storage device, a similarity hash to a similarity hash table.

In a further implementation form of the second aspect, the method further includes, in a second operating phase, determining, by the block storage device, based on a similarity hash, if a data block stored in the first operating phase can be further reduced in size using similarity de-duplication.

In a further implementation form of the second aspect, the method further includes, determining, by the block storage device, space required for storing the data block using similarity de-duplication and determining, by the block storage device, space required for storing the data block in its present format.

In a further implementation form of the second aspect, the method further includes, by the block storage device, only storing the data block in the data storage using similarity de-duplication, if the space required for storing the data block using similarity de-duplication is less than the space required for storing the data block in its present format.

In a further implementation form of the second aspect, the second operating phase is an offline phase.

The second aspect and its implementation forms include the same advantages as the first aspect and its respective implementation forms.

A third aspect of the present disclosure provides a computer program product comprising instructions which, when the program is executed by a computer, cause the computer to carry out the steps of the method of the second aspects or any of its implementation forms.

The third aspect and its implementation forms include the same advantages as the second aspect and its respective implementation forms.

A fourth aspect of the present disclosure provides a non-transitory computer-readable storage medium comprising instructions which, when executed by a computer, cause the computer to carry out the steps of the method of the second aspect or any of its implementation forms.

The fourth aspect and its implementation forms include the same advantages as the second aspect and its respective implementation forms.

In other words, the present disclosure provides a solution that determines which data-reduction method will yield the best result. For example, a data reduction method that results in better CPU performance and/or more efficient use of disk space, than another available method. Further, full advantage of the 2-phase approach can be can be taken. For example, different data-reduction methods during each phase in accordance with the design considerations and resources available in each phase lead to more efficient and effective reduction of required space. The present disclosure employs a solution that analyzes a range of parameters, such as the size of the data block, the type of read/writes normally performed at the current addresses, or the compressibility of the data, and chooses a most appropriate data-reduction method based on the outcome of that analysis. Furthermore, this analysis and decision-flow uses a 2-phase approach, with differential logic applied across inline and background processing. This allows the block storage device to prioritize performance during inline processing, when CPU usage is most critical, and to prioritize disk-space during background processing, when CPU is more available. The block storage device in particular allows to make use of at least one of these data reduction methods: de-duplication of identical blocks, compression of large blocks, compression of small blocks, similarity compression.

It has to be noted that all devices, elements, units and means described in the present disclosure could be implemented in the software or hardware elements or any kind of combination thereof. All steps which are performed by the various entities described in the present disclosure as well as the functionalities described to be performed by the various entities are intended to mean that the respective entity is adapted to or configured to perform the respective steps and functionalities. Even if, in the following description of embodiments, a functionality or step to be performed by external entities is not reflected in the description of a detailed element of that entity which performs that step or functionality, it should be clear for a skilled person that these methods and functionalities can be implemented in respective software or hardware elements, or any kind of combination thereof.

### BRIEF DESCRIPTION OF DRAWINGS

The above-described aspects and implementation forms of the present disclosure will be explained in the following description of embodiments in relation to the enclosed drawings, in which:

FIG. 1 shows a schematic view of a device according to an embodiment of the present disclosure;

FIG. 2 shows a schematic view of a device according to an embodiment of the present disclosure in more detail;

FIG. 3 shows a schematic view of an operating manner according to the present disclosure;

FIG. 4 shows a schematic view of an operating manner according to the present disclosure;

FIG. 5 shows another schematic view of a method according to an embodiment of the present disclosure.

### DETAILED DESCRIPTION OF EMBODIMENTS

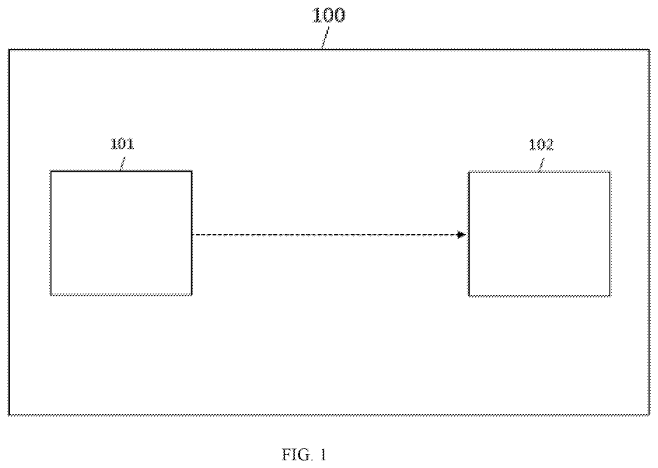

FIG. 1 shows a schematic view of a block storage device 100 according to an embodiment of the present disclosure. The block storage device 100 is for data compression and thus is configured to, if it is determined, by the block storage device 100, that a data block 101 is to be written to a large block storage area 102 of the block storage device 100, determine if the data block 101 can be de-duplicated.

Further, the block storage device 100 is configured to, if the data block 101 cannot be de-duplicated, store the data block 101 using large block compression. The data block 101 is in particular stored in the large block storage area 102.

All these steps are performed during a first operating phase. The first operating phase in particular can be an in-line phase.

Optionally, the large block storage area 102 can be an area where data blocks 101 having an average size larger than a predefined threshold are written to, and/or are read from. The large block storage area in particular may be part of a physical disc, a physical volume, a virtual disc, or a virtual volume. The average size of the to be written or to be read data block can optionally be based on a read statistic and/or a write statistic.

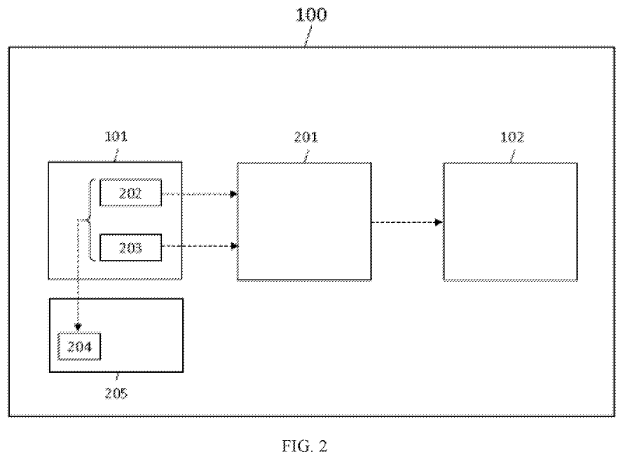

FIG. 2 shows a schematic view of a block storage device 100 according to an embodiment of the present disclosure in more detail. The device 100 shown in FIG. 2 comprises all features and functionality of the device 100 of FIG. 1, as well as the following optional features.

As it is illustrated in FIG. 2, the block storage device 100 optionally can be configured to, if the data block 101 can be de-duplicated, de-duplicate and compress the data block 101 and store the resulting data block 201. That is, instead of large block compression, de-duplication and compression of the data block 101 is performed. This kind of compression is different from large block compression in particular in that it is applied to data blocks which are smaller than the large blocks.

Further optionally, if the data block 101 can be de-duplicated, the block storage device 100 can compare a size resulting from de-duplication and compression of the data block 101 with a size resulting from large block compression of the data block 101. This evaluation assists in determining the more effective way of data reduction. If the size resulting from de-duplication and compression is larger than or equal to the size resulting from large block compression, the block storage device 100 can store the data block 101 using large block compression.

As it is further illustrated in FIG. 2, the block storage device 100 can de-duplicate a first part of sub blocks 202 of the data block 101. The block storage device 100 also can compress a second part of sub blocks 203 of the data block 101. The data block 201 which results from de-duplication and compression can then be stored by the block storage device 100. This can be done in the large block storage area 102, or in a conventional storage area of the block storage device 100. For example, if the data block 101 has a size of 1 MB, the first part of sub blocks 202 may comprise two sub blocks with a size of 256 KB each, and the second part of sub block 203 may comprise four sub blocks with a size of 128 KB each. However, any kind of distribution of sub block which follows this principle is possible.

In an embodiment, two levels of block sizes are used. In this embodiment, the data block 101 has a size of 512 KB, and a sub block has a size of 8 KB. Thus, a 512 KB data block 101 can either be compressed as a single block or as 64 sub blocks of 8 KB size, wherein each 8 KB sub block can either de-duplicated or compressed alone.

As it is further illustrated in FIG. 2, to prepare for similarity deduplication (which can be performed in a second operating phase of the block storage device 100), for each sub block 202, 203 of the data block 101, the block storage device 100 can write a similarity hash 204 to a similarity hash table 205. This step is in particular performed during the first operating phase of the block storage device 100.

Further optionally, in a second operating phase, the block storage device 100 can determine, based on a similarity hash 204, if a data block 101 stored in the first operating phase can be further reduced in size using similarity de-duplication. This similarity hash 204 can be the similarity hash stored in the similarity hash table 205 during the first operating phase.

The block storage device 100 optionally can determine space which is required for storing the data block 101 using similarity de-duplication. The block storage device 100 optionally can also determine space which is required for storing the data block 101 in its present format. This enables to only store the data block 101 in the data storage 102 using similarity de-duplication, if the space required for storing the data block 101 using similarity de-duplication is less than the space required for storing the data block 101 in its present format.

In particular, the second operating phase can be an offline phase.

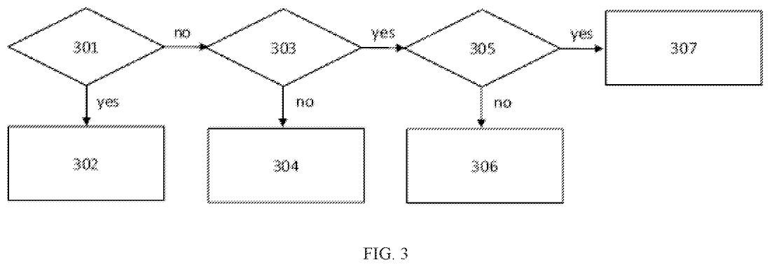

FIG. 3 describes an operating scenario which is performed during the first operating phase in more detail.

In step 301, the block storage device 100 checks, if a data block 101 can be de-duplicated (based on a hash fingerprint, it can be determined that an identical data block is already written to a disk), and if so, performs deduplication (see step 302). In any case, in step 301, the block storage device 100 generates a min-hash (i.e. the similarity hash 204) which is to be added to an opportunity table (i.e. the similarity hash table 205) to enable the possibility of similarity de-duplication later in a second operating phase.

If the data block 101 cannot be de-duplicated, the block storage device 100 checks (in step 303) a prediction table to determine, if an available range of physical addresses is usually used for writing and reading small blocks of data or large blocks of data (in other words, it is determined if the data block 101 is to be written to a large block storage area 102). If the current range is usually used for writing and reading small blocks of data, the system proceeds as usual (i.e. it stores small blocks of data), as it is illustrated in step 304.

If it is identified that the data block 101 is to be written to an area where most reads and write are done in large blocks, then the block storage device 100 analyses (in step 305), if large-block compression would yield to better compression than small-block compression. If large block compression would not lead to better compression, the block storage device proceeds as usual (i.e. it stores the compressed data block 101), see step 306. If large block compression would lead to better compression, then the block storage device 100 stores the compressed data block 101 set using large block compression (see step 307). This can be implemented by one of the following methods. Large block compression can be used to tag large block storage areas 102 as containing identical data. The block storage device 100 can write a same grain (physical) address at a same offset in each relevant large block storage area 102, or the block storage device 100 can set a bit indicating the start and end of a range of identical large block storage areas 102.

In addition, if the data block 101 can be de-duplicated, the block storage device 100 may also determine if large block compression of the data block 101 leads to a better result, or if a combination of de-duplicating and compressing the data block 101 leads to a better result, and choose the better option.

Thus, at the end of the first operating phase, the block storage device 100 generated and saved a min-hash and will have either have de-duplicated the data block 101 and/or have stored the data block 101 compressed in small blocks, or will have stored the data block 101 using large block compression.

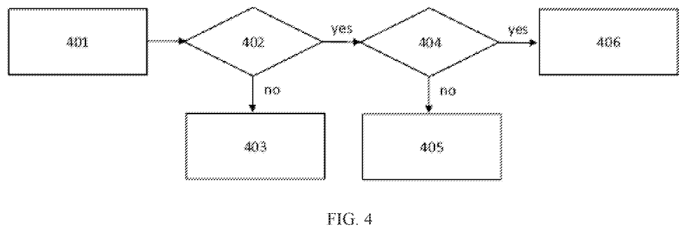

FIG. 4 describes an operating scenario which is performed during the first operating phase in more detail.

As it was explained above, the inline processing (i.e. the first operating phase) prioritized reducing CPU usage over minimizing disk usage. Then, during background processing (i.e. the second operating phase), when CPU usage is less critical, the block storage device 100 attempts to further optimize disk usage as described in the following. Step 401 of FIG. 4 is in particular performed after step 307 of FIG. 3.

As shown in step 402, in the second operating phase, for data blocks 401 compressed in large blocks of data, the block storage device 100 checks an opportunity table (i.e. the similarity hash table 205) to see, if there is an option for similarity de-duplication (i.e. if there is another data block 101, with the same min-hash).

If similarity de-duplication is not possible, the block storage device 100 does nothing, and the data block 401 remains large-block compressed, see step 403.

If similarity de-duplication is possible, then the block storage device 100 analyzes if similarity de-duplication would lead to a better result than large-block compression, see step 404.

If similarity de-duplication would lead to lower data reduction than large-block compression, the system does nothing and the data block 101 remains large-block compressed, see step 405.

If similarity de-duplication would lead to better data reduction than large-block compression, then the system performs similarity de-duplication and the data block 101 is stored in 8000 (8 k) data blocks with similarity de-duplication pointers where relevant.

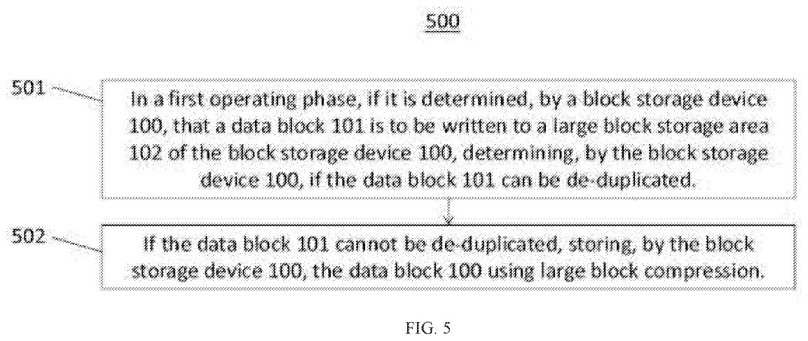

FIG. 5 shows a schematic view of a method 500 according to an embodiment of the present disclosure. The method 500 is for data compression. In a first operating phase, the method comprises a step of, if it is determined, by a block storage device 100, that a data block 101 is to be written to a large block storage area 102 of the block storage device 100, determining 501, by the block storage device 100, if the data block 101 can be de-duplicated. The method comprises (still in the first operating phase) a further step of, if the data block 101 cannot be de-duplicated, storing 502, by the block storage device 100, the data block 100 using large block compression.

The present disclosure has been described in conjunction with various embodiments as examples as well as implementations. However, other variations can be understood and effected by those persons skilled in the art and practicing the claimed disclosure, from the studies of the drawings, this disclosure, and the independent claims. In the claims as well as in the description, the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. A block storage device for data compression and comprising:
an interface; and
a processor coupled to the interface and configured to:
determine whether a data block can be de-duplicated in response to determining that the data block is to be written to a large block storage area of the block storage device, and
store the data block using large block compression when the data block cannot be de-duplicated.

2. The block storage device of claim 1, wherein the large block storage area comprises data blocks that have an average size larger than a predefined threshold and that are written to or read from the large block storage area.

3. The block storage device of claim 2, wherein the processor is further configured to determine the average size based on a read statistic or a write statistic.

4. The block storage device of claim 1, wherein an operation of determining whether the data block can be de-duplicated is an in-line phase.

5. The block storage device of claim 1, wherein the processor is further configured to de-duplicate and compress the data block to obtain a resulting data block.

6. The block storage device of claim 5, wherein the processor is further configured to compare a first size resulting from de-duplication and compression of the data block with a second size resulting from large block compression of the data block.

7. The block storage device of claim 6, wherein the processor is further configured to store the data block using the large block compression in response to the first size being larger than or equal to the second size.

8. The block storage device of claim 7, wherein the processor is further configured to:
de-duplicate a first part of sub blocks of the data block and compress a second part of the sub blocks to obtain the resulting data block; and
store the resulting data block to de-duplicate and compress the data block.

9. The block storage device of claim 8, wherein the processor is further configured to write, for each of the sub blocks, a similarity hash to a similarity hash table.

10. The block storage device of claim 1, wherein the processor is further configured to determine, based on a similarity hash, whether the data block stored in the block storage device can be further reduced in size using similarity de-duplication.

11. The block storage device of claim 10, wherein the processor is further configured to:
determine a first space required for storing the data block using the similarity de-duplication; and,
determine a second space required for storing the data block in its present format.

12. The block storage device of claim 11, wherein the processor is further configured to store the data block in the large block storage area using the similarity de-duplication when the first space is less than the second space.

13. The block storage device of claim 10, wherein an operation of determining whether the data block stored in the block storage device can be further reduced in size using the similarity de-duplication is an offline phase.

14. A method implemented by a block storage device, wherein the method comprises:
determining whether a data block can be de-duplicated in response to determining that the data block is to be written to a large block storage area of the block storage device; and
storing the data block using large block compression when the data block cannot be de-duplicated.

15. The method of claim 14, wherein the large block storage area comprises data blocks having an average size larger than a predefined threshold and are written to or read from the large block storage area.

16. The method of claim 15, further comprising determining the average size based on a read statistic and a write statistic.

17. The method of claim 14, wherein an operation of determining whether the data block can be de-duplicated is an in-line phase.

18. The method of claim 14, further comprising de-duplicating and compressing the data block to obtain a resulting data block.

19. The method of claim 18, further comprising comparing a first size resulting from de-duplication and compression of the data block with a second size resulting from the large block compression of the data block.

20. The method of claim 19, further comprising storing the data block using the large block compression in response to the first size is larger than or equal to the second size.
